(19) United States
(12) Patent Application Publication
(10) Pub. No.: US 2017/0164152 A1
(43) Pub. Date: Jun. 8, 2017

(54) SYSTEM FOR ANALYZING AND MANAGING TRAFFIC ON A GOLF COURSE

(71) Applicant: Golfswell, Inc., Washington, DC (US)

(72) Inventor: Aaron Rosenthal, Washington, DC (US)

(21) Appl. No.: 15/369,789

(22) Filed: Dec. 5, 2016

Related U.S. Application Data
(60) Provisional application No. 62/262,720, filed on Dec. 3, 2015.

(51) Int. Cl. H04W 4/02; A63B 57/30; H04L 12/933

(52) U.S. Cl. CPC H04W 4/023; H04L 49/1584; H04W 4/021; A63B 57/353; H04W 88/02

(57) ABSTRACT

One variation of a system for moderating use of a golf course includes a processor and a computer-readable device containing instructions that cause the processor to execute operations including: receiving data from one from the group consisting of a ball marker, a bag tag, and a mobile phone, the data including location and yardage data; determining, based on the received data, a traffic pattern at a time of receiving the data; determining, based on the received data, one or more segments of the golf course that are available to new players; dynamically allocating a price of a tee time based on the traffic pattern; providing, based on the received data, a scheduling option for the round; and determining, based on the received data, a cost based on one from the group consisting of an estimated time of completing the round and a number of holes included in the round.

### CROSS-REFERENCE TO RELATED APPLICATIONS

This Application claims the benefit of U.S. Provisional Application No. 62/262,720, filed on 3 Dec. 2015, which is incorporated in its entirety by this reference.

### TECHNICAL FIELD

The present disclosure generally relates to the sport of golf. More particularly, the present disclosure relates to systems for analyzing and managing traffic on a golf course.

### BACKGROUND

Golf has many recognized benefits. The sport provides a social environment in which friends and families can bond while experiencing Nature. Moreover, for the busy professional, golf is a therapeutic medium that provides stress-relief, focus, and exercise. Golf courses welcome individuals having all skill levels. Furthermore, many golf courses host competitive events geared specifically to professional players. This provides an opportunity for friends and families to travel and see their favorite professional golfer compete.

However, despite its many benefits, playing golf has also traditionally been unattractive to many people. One of the major deterrents to playing is that a typical golf session can take at least five hours to complete. Given busy professional and family lives, such time commitments are impractical for many people who actually enjoy the sport, or for people who could enjoy the sport more if playing required less time.

It has been demonstrated that one of the dominant factors that prolong a session's time is the difference in skill level of the many players playing on the same course at a given moment. For example, a group of seasoned golf players will typically complete a hole in a much faster time than a group of players who are new to the sport. Thus, having this gradient in skill level on the same course introduces delays. Golfers may be frustrated and walk off the course (or they may not come at all) because playing golf does not afford them work, family, and life balance.

Further, golf course managers manage players (or the traffic) on the course. They control how many people are on their fairways (or golf highways), when, and for how long. Currently, managers typically simply send out as many people as possible to maximize revenue. This in turn has the opposite effect, because it does not maximize the traffic flow as groups get held up by the middle of the day. It also impacts the golfing experience of others due to slow play which has reduced course revenue.

One way golf courses managers address this issue is to use a ranger to drive around the course in loops in order to compel slow players to move at a faster pace. However, this process is inherently costly and slow due to the sheer size of the typical golf course. By the time the ranger finds the slow group, it's too late because the slow group has already held up the players and course behind it.

In sum, golf's major problem is that people are turning away because they do not have the time. People do not golf because they are frustrated when they get to the course and have to wait. Golf takes too long (sometimes 5 hours or more), and some people don't have this much time to devote to sport in a day. Another issue is scheduling; the result of slow play, and golf taking longer than people would like, is that there is extreme unpredictability built in to scheduling a round of golf. In other words, since people cannot be sure when they book a round if it will take longer than expected, they cannot beforehand know whether they can fit the round into their other activities. As such, they simply choose to not schedule rounds when they may still want to play.

### SUMMARY

Given the aforementioned deficiencies, what is needed are methods and systems that will optimize the way golf is played, the way a player books tee times and schedules a game, and the way courses analyze and manage traffic.

The present disclosure provides the ability to track players on a golf course using a ball marker. Further, the present disclosure allows tracking with a mobile device (such as a mobile phone) as a complement or separate option from tracking players with the ball marker. Furthermore, in embodiments of the present disclosure, one or more ball markers may be used on a mesh network.

Moreover, the present disclosure provides the ability to book just a few holes and use a mobile phone as a means for payment; a golfer may be charged for just a few holes or simply based on time spent on the course. This can be completed by showing confirmation to starter or a pro shop attendant or just by walking out and playing. According to the present disclosure, a round (purchase) begins when the player crosses the first tee or the hole they selected to start on based on geo-fencing and using course start location GPS coordinates obtained from the player's mobile phone/ball marker. In some embodiments, a bag tag can also be configured to provide location and yardage data, and as such, the bag tag may be substituted for the ball marker. A hardware device affixed to a golf cart can also be substituted for the ball marker or bag tag or used in conjunction to provide location information.

Further, this disclosure allows easy booking and scheduling because the disclosed embodiments allow a player to know how long it will take to play before heading to the course. As such, by showing golfers in advance the time it will actually take to play, golf courses are able to fill unused tee times that would otherwise remain unfilled because people do not have that information. This is counterintuitive, as most people/courses mangers think golfers will keep away if they see that the course is crowded. But if players know a course can provide a steady and consistent pace, a feature that is enabled by the embodiments disclosed herein, they will know that a 4-hour round will actually take 4 hours. Uncrowded courses can use that information to attract customers who want to play golf in a shorter amount of time. Furthermore, the disclosed embodiments will permit new people to come and play the sport once the large time commitment is removed and they have the option of just playing one or a few holes.

In one exemplary embodiment, the present disclosure provides a system 100 for use at a golf course that includes a processor and a computer-readable device comprising instructions that when executed by the processor cause the processor to execute certain operations. The operations may include receiving data from a plurality of ball markers. The operations may also include receiving the data from one of a bag tag hardware device and a mobile device, such as a smart phone. The received data may include location and yardage data associated with each ball marker of the plurality of ball markers. The operations may further include determining, based on the received data, a traffic pattern during a time period associated with the time of receiving the data. Furthermore, the operations may include determining, based on a received data, one or more segments of the golf course that are available for new players to use. The operations may also include dynamically allocating a price of a tee time based on the traffic pattern.

Additional features and advantages, as well as the structure and operation of the various embodiments, are described in detail below with reference to the accompanying drawings.

It is noted that the disclosure is not limited to the specific embodiments described herein. Such embodiments are presented for illustrative purposes only. Additional embodiments will be apparent to persons skilled in the relevant art(s) based on the teachings contained herein.

### BRIEF DESCRIPTION OF THE FIGURES

Illustrative embodiments may take form in various components and arrangements of components, as shown in the accompanying drawings. The drawings are only for purposes of illustrating the embodiments and are not to be construed as limiting the disclosure. Given the following enabling description of the drawings, the novel aspects of the present disclosure should become evident to a person of ordinary skill in the art.

FIG. 1 is a flowchart representation of a system;

FIGS. 2A-2C are graphical representations of variations of the system;

FIG. 3 is a graphical representations of one variation of the system;

FIG. 4 is a flowchart representation of one variation of the system;

FIG. 5 is a graphical representations of one variation of the system; and

FIG. 6 is a graphical representation of one variation of the system.

### DETAILED DESCRIPTION

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

While illustrative embodiments are described herein for particular applications, it should be understood that the present disclosure is not limited thereto. Those skilled in the art with access to the teachings provided herein will recognize additional modifications, applications, and embodiments within the scope thereof and additional fields in which the present disclosure would be of significant utility.

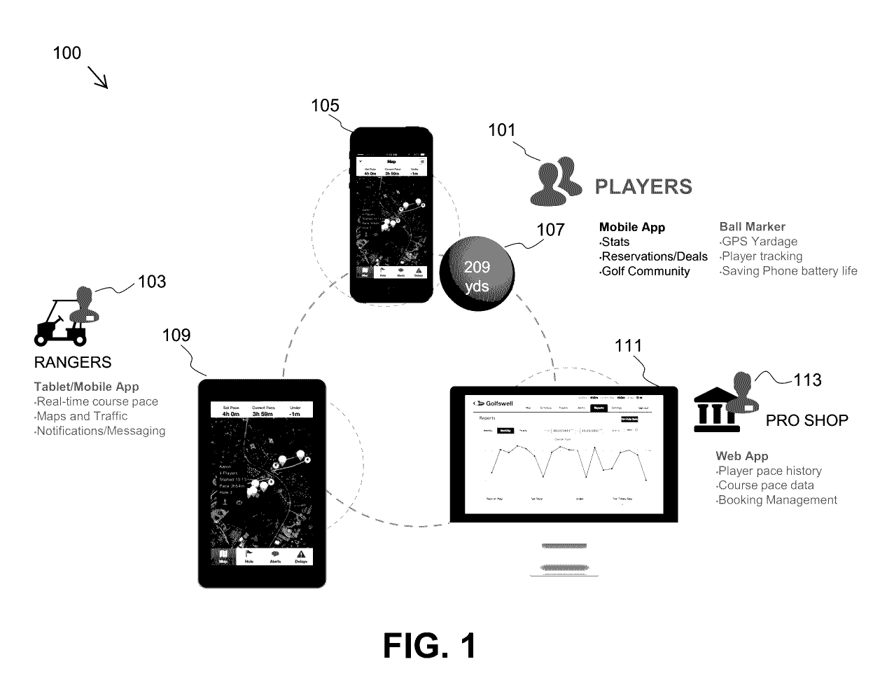

FIG. 1 is an illustration of a system 100, according to an embodiment. The system 100 100 includes a plurality of devices, such as device 105, 109, and 111. The system 100 100 can include a server configured to support and service the devices 105, 109, 111, and 107, wherein the device 107 is a ball marker, as described below.

Although a specific number of devices are shown in FIG. 1, the system 100 100 can include more, or fewer, devices than shown. By way of example, a device in the system 100 100 can be a computing device connected to other devices of the system 100 100 using a network. For example, in FIG. 1, the device 105 can be a smart phone, the device 109 can be a tablet PC, and device 111 could be a desktop computer. The system 100 100 enables players 101, rangers 103, and shop personnel 105, associated with a given golf course, to interact.

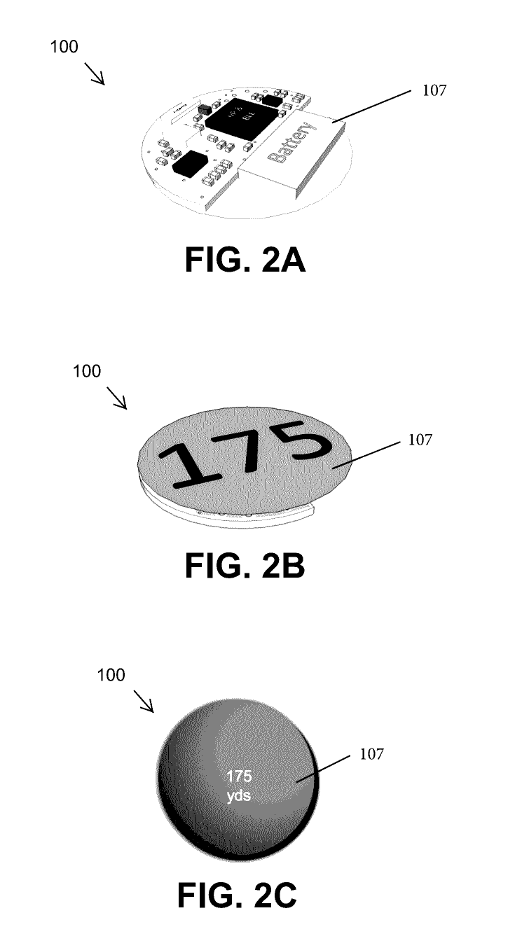

The players 101 can each have a ball marker 107, such as the exemplary embodiments 200 shown in FIGS. 2A-2C. As an example, the ball marker 107 can include electronics for registering the location of a player's ball on the golf course. Locating a player on the golf course can also be done by the player's smart phone (such as device 105). This may done by pairing an application to the phone via a wireless communication protocol, such as Bluetooth, in order to communicate location data back to the server, along with GPS. This can be done using a mesh networking of the golf course. The ball marker 107 can include a button or any other suitable actuation mechanism that triggers the electronics disposed therein to transmit the current location associated with a ball to at least one of the devices 105, 109, and 111. The location is associated with the player, or the group of players, utilizing the ball marker 107.

The ball marker 107 can continuously (or in predetermined time intervals) transmit and/or display its current location and the current yardage. Further, the ball marker 107, by virtue of the electronics disposed therein, may be configured to display and/or transmit yardage information to at least one of device 105, 109, and 111.

Additionally, the ball marker 107 can include global positioning system (GPS) electronics for registering location and conveying yardage information. The ball marker 107 can also include an accelerometer, and it may use dead reckoning to transmit location and yardage data in reference to last known GPS point. The ball marker 107 can include a battery (e.g., rechargeable or replaceable). The ball marker 107 can also include photovoltaic cells or the like, thereby allowing it to be powered by sunlight or ambient light energy.

The ball marker 107 can also include inertial sensors capable of registering location and yardage information. This feature can be useful on courses where GPS coverage is poor or nonexistent. Other methods for registering position and location can be used. By way of example, and not by limitation, radio-frequency (RF) location and navigation methods based on received signal strength indication (RSSI), link quality index (LQI), or time-difference of arrival (TDOA) are also viable methods.

The devices 105, 109, and 111 can each be configured to provide additional utility. For example, the rangers 103 may receive real time course pace data. The course pace data can be obtained by tracking the ball marker 107 or the smart phone 105 using at least one of the devices 105, 109, and 111. Alternatively, the rangers 103 can track data for a plurality of ball markers, such as the ball marker 107, each ball marker of the plurality being associated with one or more players 101. The rangers 103 can visualize a map of the golf course or of sections of the golf course, thus obtaining a live picture of course traffic. The system 100 100 can also support a messaging/notification service, allowing the rangers 103 to communicate with other entities on the course (e.g. players 107 and/or shop personnel 113).

The system 100 100 can log pace data associated with a player. Pace is defined herein as a speed or a rate, or any similar metric, that indicates how fast a player moves along the course. The system 100 100 allows the shop personnel 113 to access a pace history associated with a particular player. The system 100 100 can also allow shop personnel 113 to view current or historical pace data for a plurality of players. The system 100 100 can also compute, by a server, an average pace data associated with the course for any present or past time period.

The system 100 100 can permit players 107 to view statistics associated with their current or past golf rounds. The players 101 can view their own statistics including but not limited to the distance of their shots or that of their friends or other players associated with the device 105. Further, the system 100 100 allows players 101 to book future golf rounds using the device 105 or an affiliated website. It can also offer advertisements to players 107 via device 105.

The system 100 100 is configurable for dynamically adjusting the price of a tee time based on the real time data provided by the plurality of ball markers 107 on the course or smart phones 105. For example, the system 100 100 can increase or decrease the price of a given tee time based on the current average pace registered on the course.

The system 100 100 can allocate tee times for a single hole of golf, as opposed to only 9 or 18 holes as is currently offered. This process can be achieved by analyzing course pace and traffic, dynamically identifying holes that are free for other players to use. For example, the system 100 100 can determine, based on traffic volume computed from a plurality of ball markers 107 or smart phones 105, that a 3-hole segment may be allocated without adversely affecting overall course traffic. Conversely, the system 100 100 can allocate a 16-hole segment based on the measured traffic volume.

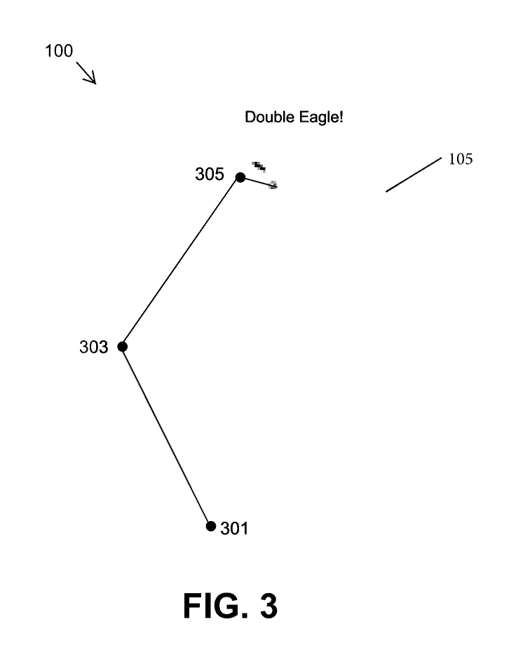

FIG. 3 is an illustration of a golf course 300 in which embodiments of the present disclosure may be used. Points 301, 303, and 305 are locations of the ball marker 107 as players 101 progress from the start of the hole to completion. The system 100 100 can transmit visual data, shown in FIG. 3, to any one of the devices 105, 109, and 111. As previously stated, the ball marker 107 allows marking a location of a ball as well as providing course yardage. The players may also connect with fellow players, compare statistics, and visualize a leaderboard.

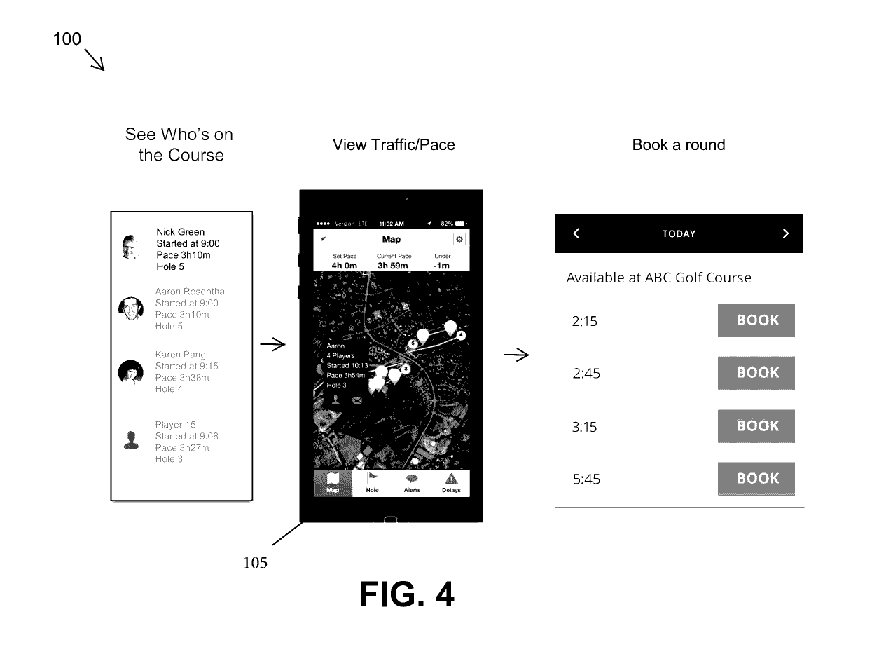

During and after a round, shots may be plotted on a map of the course. As shown in FIG. 4, the system 100 100 can be used offline by players to visualize current and past activity on a selected golf course. Players who are not on the course may view activity and pace of their friends, and these data may be shared among players. Furthermore, the system 100 100 can be connected to a plurality of golf courses to offer to enable offline players to compare activity on several courses.

The system 100 100 can also allow players to book rounds, and a price for a tee time, with the course's round time length being dynamically computable, as explained above. As such, players could be incentivized to play golf, since the disclosed system allows live traffic management, player tracking, dynamic tee time pricing, and short or long segment allocation.

From the perspective of shop personnel 113, the system 100 100 allows locating players, speeding up play, creating playing efficiency, while providing an effective way to connect with and sell to customers. The embodiments offer the advantage of providing increased revenues for golf courses.

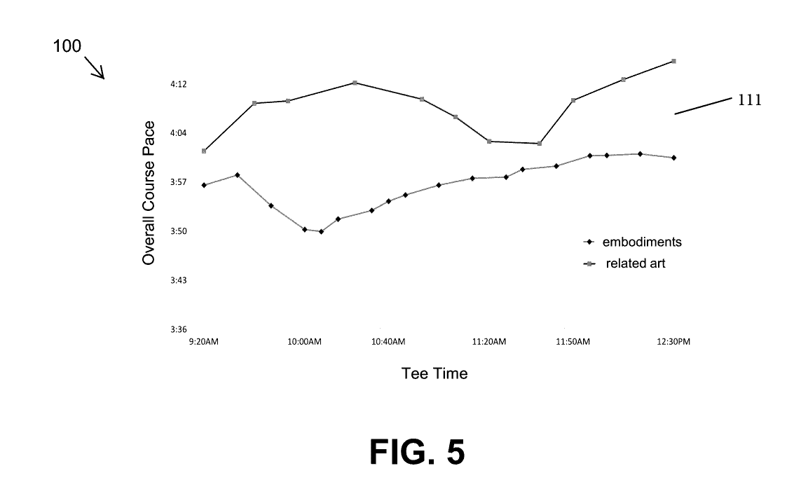

As shown in FIG. 5, the embodiments can increase pace (i.e. shorter play times on the y-axis) during a given day (time, x-axis). These data showed over 15 minute-decrease in overall round time, corresponding to 59% increase in efficiency.

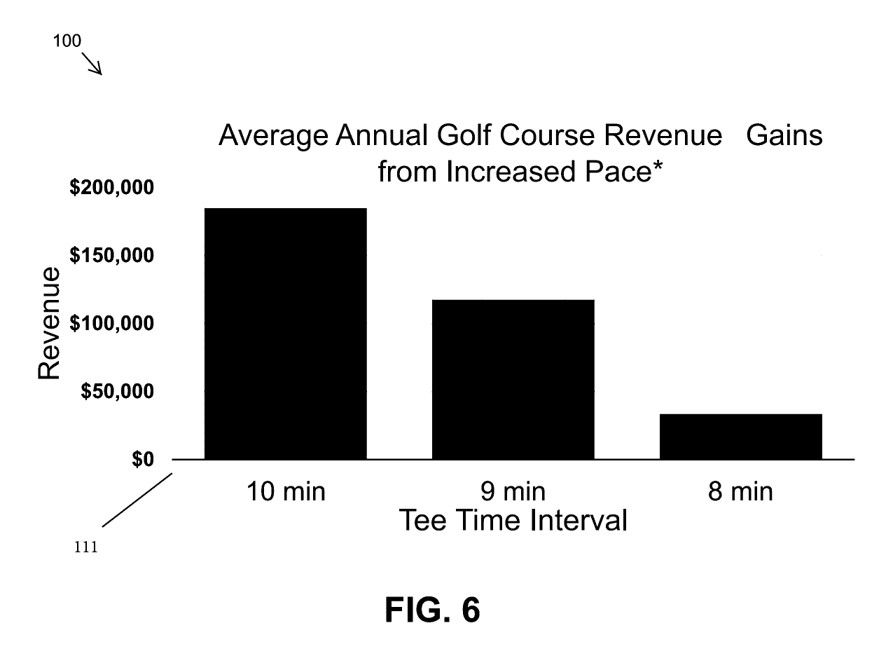

In FIG. 6, increasing pace directly correlates with increased revenues. The exemplary data of FIG. 6 are based on a price of $50 per tee time for a 28-week golfing season. The way revenue is gained is from changing the intervals in between tee times. As a result of improving a course's pace of play with system 100, golf course managers may now optimize and reduce the time in between players accordingly so they can fit more golfers on the course and have players finish a round in a desired time. Thus, system 100 provides for a better playing experience.

System 100 can also provide tee time interval automation. This can be done using pace of play and player round history and handicap data collected and logged by system 100. System 100 can automate the process of determining an appropriate number of minutes to allot in between groups (tee time interval) to optimize throughput and achieve desired course pace time. This feature may be integrated with golf course tee time scheduling software.

Alternative embodiments, examples, and modifications which would still be encompassed by the present disclosure may be made by those skilled in the art, particularly in light of the foregoing teachings. Further, it should be understood that the terminology used to describe the disclosure is intended to be descriptive rather than limiting. Those skilled in the relevant art(s) will also appreciate that various adaptations and modifications of the embodiments described above can be implemented without departing from the scope and spirit of the disclosure. Therefore, it is to be understood that, within the scope of the appended claim, the disclosure may be practiced other than as specifically described herein.

I claim:

1. A system for moderating use of a golf course, comprising:
a processor; and
a computer-readable device comprising instructions that when executed by the processor cause the processor to execute operations comprising:
receiving data from one from the group consisting of a ball marker, a bag tag, and a mobile phone, the data including location and yardage data;
determining, based on the received data, a traffic pattern at a time of receiving the data;
determining, based on the received data, one or more segments of the golf course that are available to new players;
dynamically allocating a price of a tee time based on the traffic pattern;
providing, based on the received data, a scheduling option for the round; and
determining, based on the received data, a cost based on one from the group consisting of an estimated time of completing the round and a number of holes included in the round.
